(19) United States
(12) Patent Application Publication
(10) Pub. No.: US 2025/0210617 A1
(43) Pub. Date: Jun. 26, 2025

(54) POUCH BATTERY CELL FOR PREVENTING LITHIUM PLATING IN THE PRESENCE OF A TORN ANODE TAB

(71) Applicant: GM GLOBAL TECHNOLOGY OPERATIONS LLC, Detroit, MI (US)

(72) Inventors: Thanh-Son DAO, Rochester Hills, MI (US); Meng JIANG, Rochester Hills, MI (US); Mingjie TU, Sterling Heights, MI (US); Jingyuan LIU, Shaanghai (CN); Jian GAO, Auburn Hills, MI (US); Louis G. HECTOR, JR., Shelby Township, MI (US)

(21) Appl. No.: 18/423,613

(22) Filed: Jan. 26, 2024

(30) Foreign Application Priority Data
Dec. 22, 2023 (CN) 202311785219.2

(51) Int. Cl. H01M 4/04; H01M 10/04; H01M 10/615; H01M 10/647

(52) U.S. Cl. CPC H01M 4/0404; H01M 10/0413; H01M 10/615; H01M 10/647; H01M 2220/20

(57) ABSTRACT

A method for manufacturing a battery cell comprising manufacturing C cathode electrodes by coating first and second cathode active material layers on opposite sides of C cathode current collectors, and applying first and second seal coatings on the C cathode current collectors to surround the first and second cathode active material layers, respectively. The method includes manufacturing A anode electrodes by coating first and second anode active material layers on opposite sides of A anode current collectors; and applying first and second seal coatings on the A anode current collectors to surround the first and second anode active material layers, respectively. The method includes arranging S separators between the C cathode electrodes and the A anode electrodes to form a battery cell stack, where C, A and S are integers greater than one.

### CROSS-REFERENCE TO RELATED APPLICATIONS

This application claims the benefit of Chinese Patent Application No. 202311785219.2, filed on Dec. 22, 2023. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to a clad terminal embedded in a separator of a battery cell.

Electric vehicles (EVs) such as battery electric vehicles (BEVs), hybrid ‘system include one or more battery cells, modules, and/or packs. A power control system is used to control charging and/or discharging of the battery system during charging and/or driving.

Battery cells include one or more cathode electrodes, anode electrodes, and separators. The cathode electrodes include a cathode active material layer (including cathode active material) arranged on a cathode current collector. The anode electrodes include an anode active material layer (including anode active material) arranged on an anode current collector.

### SUMMARY

A method for manufacturing a battery cell inludes manufacturing C cathode electrodes by coating first and second cathode active material layers on opposite sides of C cathode current collectors, and applying first and second seal coatings on the C cathode current collectors to surround the first and second cathode active material layers, respectively. The method includes manufacturing A anode electrodes by coating first and second anode active material layers on opposite sides of A anode current collectors; and applying first and second seal coatings on the A anode current collectors to surround the first and second anode active material layers, respectively. The method includes arranging S separators between the C cathode electrodes and the A anode electrodes to form a battery cell stack, where C, A and S are integers greater than one.

In other features, the first and second seal coatings comprise a polymer coating. The method includes sealing three sides of the battery cell stack by heating the first, second, third and fourth seal coatings along the three sides of the battery cell stack. The method includes arranging the battery cell stack in an enclosure. The enclosure comprises a pouch enclosure. The method includes adding liquid electrolyte to the enclosure and allowing the enclosure to de-gas.

In other features, the method includes sealing a remaining side of the battery cell stack and the enclosure. The method includes sealing a remaining side of the battery cell stack and the enclosure using first and second sealing bars. The method includes applying a pre-treatment coating prior to applying at least one of the first, second, third, and fourth seal coatings to enhance bonding of the at least one of the first, second, third, and fourth seal coatings. The pre-treatment coating is selected from a group consisting of vinyl phosphoric acid (VPA) and chromate. The method includes defining a predetermined gap between the first and second seal coatings and the first and second cathode active material layers, respectively.

A method for manufacturing a battery cell includes providing C cathode electrodes including first and second cathode active material layers arranged on opposite sides of C cathode current collectors, and first and second seal coatings arranged on the C cathode current collectors and surrounding the first and second cathode active material layers, respectively. The method includes providing A anode electrodes including first and second anode active material layers arranged on opposite sides of A cathode current collectors, and first and second seal coatings arranged on the A anode current collectors and surrounding the first and second anode active material layers, respectively. The method includes arranging S separators between the C cathode electrodes and the A anode electrodes to form a battery cell stack, sealing three sides of the battery cell stack by heating the first, second, third and fourth seal coatings along the three sides of the battery cell stack, arranging the battery cell stack in a pouch enclosure, adding liquid electrolyte to the enclosure and allowing the enclosure to de-gas, and sealing a remaining side of the battery cell stack and the enclosure.

In other features, the first and second seal coatings comprise a polymer coating. The method includes sealing the remaining side of the battery cell stack and the enclosure includes applying heat using first and second sealing bars. The method includes applying a pre-treatment coating prior to applying at least one of the first, second, third, and fourth seal coatings to enhance bonding of the at least one of the first, second, third, and fourth seal coatings. The pre-treatment coating is selected from a group consisting of vinyl phosphoric acid (VPA) and chromate.

A battery cell includes a battery cell stack including S separators, A anode electrodes, and C cathode electrodes each including a cathode current collector, a first cathode active material layer arranged on a first side of the cathode current collector. A first sealing ring is arranged on the cathode current collector around the first cathode active material layer. A second cathode active material layer arranged on a second side of the cathode current collector. A second sealing ring is arranged on the cathode current collector around the second cathode active material layer. The first sealing ring seals the cathode current collector to one of the S separators around the first cathode active material layer. The second sealing ring seals the cathode current collector to one of the S separators around the second cathode active material layer.

In other features, each of the A anode electrodes includes an anode current collector, a first anode active material layer arranged on a first side of the anode current collector, a third sealing ring arranged on the anode current collector around the first anode active material layer, a second anode active material layer arranged on a second side of the anode current collector, and a fourth sealing ring arranged on the anode current collector around the second anode active material layer. The third sealing ring seals the anode current collector to one of the S separators around the first anode active material layer. The fourth sealing ring seals the anode current collector to one of the S separators around the second anode active material layer.

In other features, a pouch enclosure surrounds the battery cell stack. A liquid electrolyte is arranged in the pouch enclosure.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross sectional view of an example of a battery cell including anode electrodes, cathode electrodes and separators;

FIG. 2 is a plan view illustrating an example of manufacturing of cathode electrodes using a roll-to-roll process with skip coating according to the present disclosure;

FIGS. 3A and 3B are plan views illustrating examples of cathode and anode electrodes after blanking according to the present disclosure;

FIGS. 4A and 4B are side views illustrating examples of cathode and anode electrodes according to the present disclosure;

FIG. 5 is a side cross sectional view illustrating an example of a battery cell stack according to the present disclosure;

FIGS. 6A to 6C are plan views illustrating an example of manufacturing of the battery cell according to the present disclosure;

FIGS. 7A to 7B are side cross sectional views illustrating an example of manufacturing of the battery cell according to the present disclosure; and

FIG. 8A is a plan view illustrating an example of manufacturing of the battery cell according to the present disclosure;

FIG. 8B is a side cross sectional view illustrating an example of manufacturing of the battery cell according to the present disclosure; and

FIG. 8C is a plan view illustrating an example of manufacturing of the battery cell according to the present disclosure.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

As a result of a fabrication process of a pouch battery cell, electrolyte bridge formation occurs between adjacent unit cells which causes lithium plating (e.g., due to a torn anode tab during battery operation and/or manufacturing/assembly). In some battery cells, welds joining external tabs on the anode electrode may detach due to excessive tension and bending during battery operation. As a result, excessive lithium by-products form on an edge of the torn external tab which may lead to internal short circuits. One example is needle-like lithium metal dendrite penetration of the separator.

The present disclosure relates to a pouch battery cell that seals liquid electrolyte within each unit cell. A seal is formed on the cathode and anode current collectors around the cathode and anode active material layers. The seal prevents excessive lithium plating on edges of the anode electrode. The seal also allows empty spaces adjacent to the active material layers to be filled with excess electrolyte and prevents formation of electrolyte bridges between unit cells in each stack. As a result, lithium plating is avoided. A method for manufacturing the battery cells allows the seals to be formed while still allowing electrolyte filling and de-gassing of the pouch battery cell.

Manufacturing of the battery cells can be performed using a roll-to-roll process with skip coating. Skip coating refers to coating the current collector with a slurry corresponding to an active material layer for a discrete length of the current collector followed by a predetermined gap (or skip) and then repeating. A seal coating is formed on the cathode and anode current collectors spaced from and around the cathode and anode active material layers. In some examples, the seal is made of a polymer coating. Pressure and/or heat is/are used to melt the seal coating to seal the edges of the unit cell and to form empty spaces for electrolyte reservoirs within each of the unit cells.

In some examples, the anode or cathode current collectors are pretreated with a coating to enhance bonding with the seal coating (e.g., a polymer coating). For example, the pretreatment coating may include vinyl phosphoric acid (VPA), chromate, or another coating that increases the strength of the bond to the seal coating forming the seal.

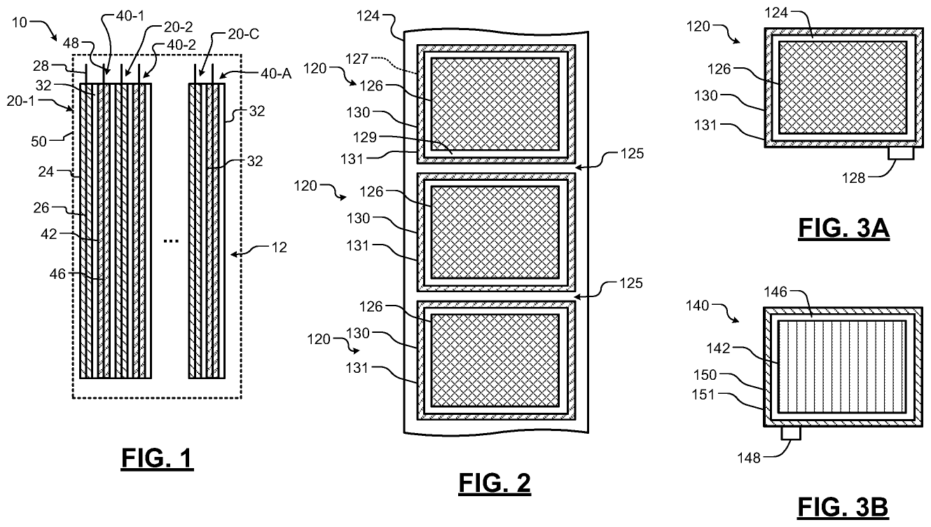

Referring now to FIG. 1, a battery cell 10 typically includes C cathode electrodes 20, A anode electrodes 40, and S separators 32 arranged in a predetermined sequence in a battery cell stack 12, where C, S and A are integers greater than zero. The C cathode electrodes 20-1, 20-2, . . . , and 20-C include cathode active material layers 24 arranged on one or both sides of a cathode current collector 26.

In some examples, the A anode electrodes 40 and the C cathode electrodes 20 exchange lithium ions during charging/discharging. The A anode electrodes 40-1, 40-2, . . . , and 40-A include anode active material layers 42 arranged on one or both sides of the anode current collectors 46. In some examples, the cathode active material layers 24 and/or the anode active material layers 42 comprise coatings including one or more active materials, one or more conductive additives, and/or one or more binder materials that are applied to the current collectors (e.g., using a wet or dry roll-to-roll process).

In some examples, the cathode current collector 26 and/or the anode current collector 46 comprises metal foil, metal mesh, perforated metal, 3 dimensional (3D) metal foam, and/or expanded metal. In some examples, the current collectors are made of one or more materials selected from a group consisting of copper, stainless steel, brass, bronze, zinc, aluminum, and/or alloys thereof. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

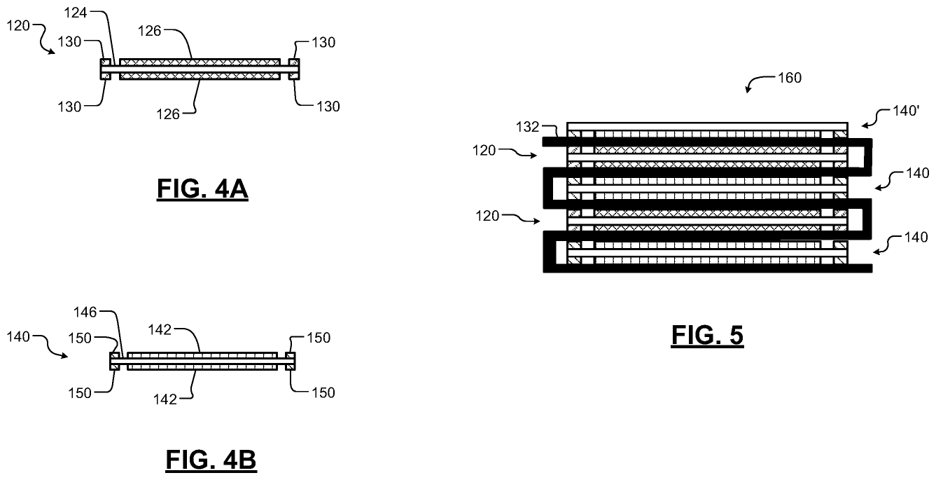

Referring now to FIGS. 2 to 3B, manufacturing of example electrodes (e.g., C cathode electrodes 120 using roll-to-roll manufacturing with skip coating or another suitable method is shown. In FIGS. 2 and 3A, cathode active material layers 126 are coated onto a continuous cathode current collector 124 with predetermined spaces 125 therebetween. The predetermined spaces 125 provide space for a seal coating 130, external tabs, and space for cutting between adjacent electrodes.

A seal coating 130 is applied around each of the cathode active material layers 126. In some examples, the seal coating 130 comprises a polymer coating. In some examples, a predetermined gap 129 is formed between an inner edge of the seal coating 130 and an outer edge of the cathode active material layer 126.

During manufacturing, the seal coating 130 is pressed and/or heated to form a sealing ring 131 enclosing the cathode active material layer 126 and electrolyte between the cathode current collector 124 and the corresponding separator. The seal coating 130 is spaced by the predetermined gap 129 from the cathode active material layer 126. The seal coating 130 is spaced by a second predetermined distance from an adjacent polymer coating for an adjacent cathode active material layer 126 to allow external tabs. In some examples, the cathode active material layers 126 has a rectangular shape and the seal coating 130 has a rectangular frame shape. A similar approach is used for A anode electrodes 140 shown in FIG. 3B.

In some examples, a pre-treatment coating 127 is applied to areas that are to be coated with the seal coating 130 prior to application of the seal coating 130 to enhance bonding between the current collector and the seal coating 130. For example, the pre-treatment coating 127 may include vinyl phosphoric acid (VPA), chromate, or another coating material that increases the strength of the bond between the seal coating 130 and the anode current collector 146 in FIG. 3B.

Referring now FIGS. 3A and 3B, the C cathode electrodes 120 and the A anode electrodes 140 are separated and external tabs are defined (e.g., the electrodes are blanked). In FIG. 3A, the C cathode electrodes 120 further include an external tab 128.

In FIG. 3B, the anode electrode 140 includes an anode active material layer 142 arranged on an anode current collector 146. A seal coating 150 is spaced from and surrounds the anode active material layer 142. In some examples, a predetermined gap is formed between an inner edge of the seal coating 150 and an outer edge of the anode active material layer 142 and between adjacent anode electrodes as described above.

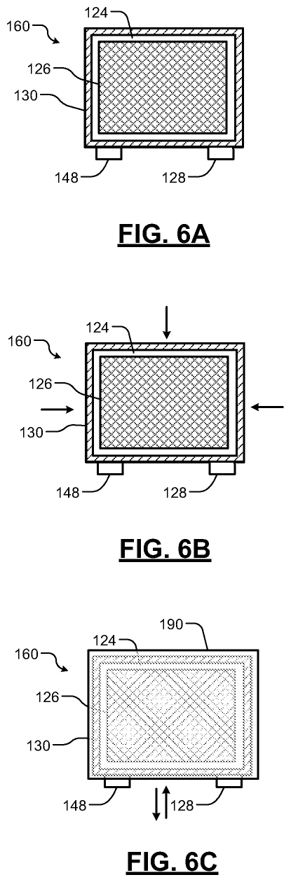

During manufacturing, the seal coating 150 is pressed and/or heated to form a sealing ring 151 enclosing the anode active material layer 142 and electrolyte between the anode current collector 146 and the corresponding separator 132 in FIG. 5. The A anode electrodes 140 include an external tab 148. In some examples, the external tab 128 of the C cathode electrodes 120 is located on the same side as the external tab 148 of the anode electrode 140 (with a spacing offset). In other examples, the external tabs 128 and 148 are located on different (opposite or adjacent) sides.

Referring now to FIGS. 4A and 4B, the C cathode electrodes 120 and the A anode electrodes 140 can be double-sided. In FIG. 4A, the cathode active material layers 126 are formed on both sides of the cathode current collector 124. In FIG. 4B, the anode active material layers 142 are formed on both sides of the anode current collector 146.

Referring now to FIG. 5, the C cathode electrodes 120, the anode electrodes 140, and separators 132 form a battery cell stack 160. In some examples, the separators 132 include a continuous layer (shown) or a plurality of discrete layers (not shown). In some examples, one or more of the anode electrodes 140′ (and/or C cathode electrodes 120) may be single-sided.

Referring now to FIGS. 6A to 6C, three sides of the battery cell stack 160 are initially sealed by applying heat and/or pressure to the seal coatings 130 and 150 (FIGS. 6A and 6B) as shown by the inward pointing arrows in FIG. 6B. In FIG. 6C, the battery cell stack 160 is arranged in a pouch enclosure 190 after sealing three sides. After sealing the three sides, the battery cell stack is inserted into an enclosure with an open side and three enclosed sides.

Electrolyte is added and the remaining side of the enclosure is sealed. A sealing location of the enclosure is aligned with the seal coating of the corresponding side. After formation, degassing occurs by opening the pouch enclosure. After the formation and degassing, the pouch material is resealed and the sealing position is aligned with the seal coating.

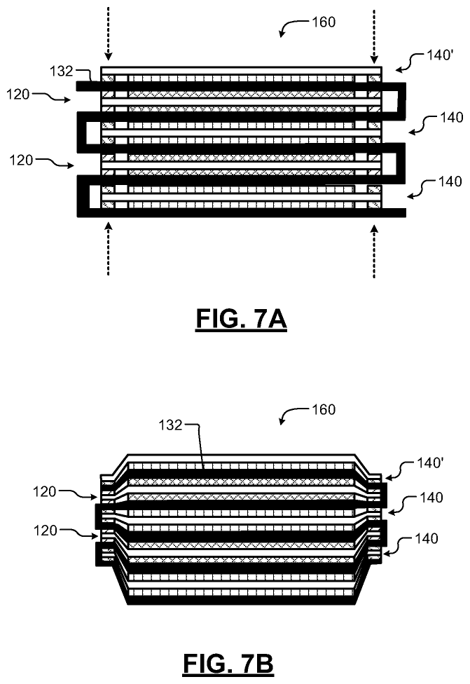

Referring now to FIGS. 7A and 7B, sealing of the three sides of the battery cell stack 160 using the seal coatings 130 and 150 is shown. Heat and/or pressure are applied to the seal coatings 130 and 150 to seal the separator(s) 132 and the anode current collectors and cathode current collectors as shown in FIG. 7B.

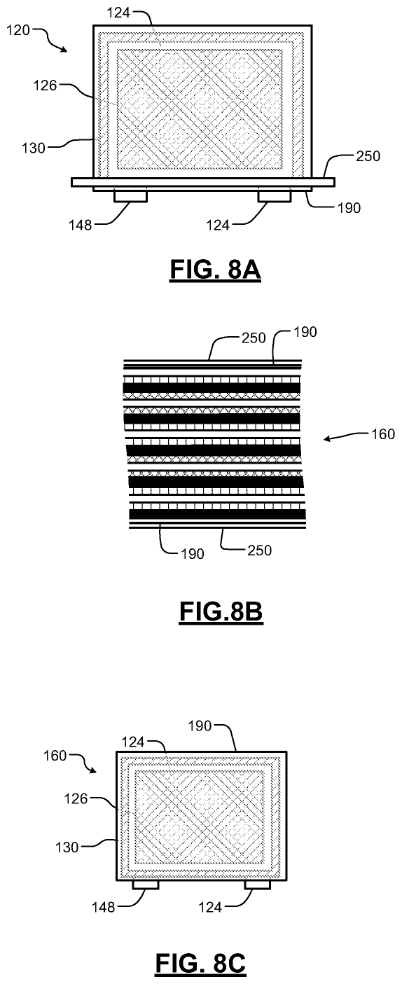

Referring now to FIG. 8A to 8C, after arranging the battery cell stack 160 in the pouch enclosure 190 and sealing the three sides of the battery cell stack 160, a seal bar 250 or other device may be used to apply heat and/or pressure to seal a last one of the edges of the pouch enclosure 190 after filling with electrolyte and de-gassing.

The use of the seal coating to seal the unit cells of the battery cell offers another protection layer to the pouch battery cell by preventing lithium plating on the edge of the anode electrode when the external tab of the anode electrode is torn or has another defect. The seal coating defines pockets that are filled with additional liquid electrolyte to prevent the electrolyte from drying out during charging/discharging which increases battery life. The battery cells utilize low-cost materials and existing fabrication processes to minimize added costs to cell manufacturing.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A method for manufacturing a battery cell comprising:
manufacturing C cathode electrodes by:
coating first and second cathode active material layers on opposite sides of C cathode current collectors; and
applying first and second seal coatings on the C cathode current collectors to surround the first and second cathode active material layers, respectively;
manufacturing A anode electrodes by:
coating first and second anode active material layers on opposite sides of A anode current collectors; and
applying first and second seal coatings on the A anode current collectors to surround the first and second anode active material layers, respectively; and
arranging S separators between the C cathode electrodes and the A anode electrodes to form a battery cell stack, where C, A and S are integers greater than one.

2. The method of claim 1, wherein the first and second seal coatings comprise a polymer coating.

3. The method of claim 1, further comprising sealing three sides of the battery cell stack by heating the first, second, third and fourth seal coatings along the three sides of the battery cell stack.

4. The method of claim 3, further comprising arranging the battery cell stack in an enclosure.

5. The method of claim 4, wherein the enclosure comprises a pouch enclosure.

6. The method of claim 4, further comprising adding liquid electrolyte to the enclosure and allowing the enclosure to de-gas.

7. The method of claim 6, further comprising sealing a remaining side of the battery cell stack and the enclosure.

8. The method of claim 6, further comprising sealing a remaining side of the battery cell stack and the enclosure using a sealing bar.

9. The method of claim 1, further comprising applying a pre-treatment coating prior to applying at least one of the first, second, third, and fourth seal coatings to enhance bonding of the at least one of the first, second, third, and fourth seal coatings.

10. The method of claim 9, wherein the pre-treatment coating is selected from a group consisting of vinyl phosphoric acid (VPA) and chromate.

11. The method of claim 1, further comprising defining a predetermined gap between the first and second seal coatings and the first and second cathode active material layers, respectively.

12. A method for manufacturing a battery cell comprising:
providing C cathode electrodes including:
first and second cathode active material layers arranged on opposite sides of C cathode current collectors; and
first and second seal coatings arranged on the C cathode current collectors and surrounding the first and second cathode active material layers, respectively;
providing A anode electrodes including:
first and second anode active material layers arranged on opposite sides of A cathode current collectors; and
first and second seal coatings arranged on the A anode current collectors and surrounding the first and second anode active material layers, respectively;
arranging S separators between the C cathode electrodes and the A anode electrodes to form a battery cell stack;
sealing three sides of the battery cell stack by heating the first, second, third and fourth seal coatings along the three sides of the battery cell stack;
arranging the battery cell stack in a pouch enclosure;
adding liquid electrolyte to the enclosure and allowing the enclosure to de-gas; and
sealing a remaining side of the battery cell stack and the enclosure.

13. The method of claim 12, wherein the first and second seal coatings comprise a polymer coating.

14. The method of claim 12, wherein sealing the remaining side of the battery cell stack and the enclosure includes applying heat using first and second sealing bars.

15. The method of claim 12, further comprising applying a pre-treatment coating prior to applying at least one of the first, second, third, and fourth seal coatings to enhance bonding of the at least one of the first, second, third, and fourth seal coatings.

16. The method of claim 15, wherein the pre-treatment coating is selected from a group consisting of vinyl phosphoric acid (VPA) and chromate.

17. A battery cell comprising:
a battery cell stack including:
S separators;
A anode electrodes; and
C cathode electrodes each including a cathode current collector, a first cathode active material layer arranged on a first side of the cathode current collector, a first sealing ring arranged on the cathode current collector around the first cathode active material layer, a second cathode active material layer arranged on a second side of the cathode current collector, and a second sealing ring arranged on the cathode current collector around the second cathode active material layer,
wherein the first sealing ring seals the cathode current collector to one of the S separators around the first cathode active material layer, and
wherein the second sealing ring seals the cathode current collector to one of the S separators around the second cathode active material layer.

18. The battery cell of claim 17, wherein:
each of the A anode electrodes includes an anode current collector, a first anode active material layer arranged on a first side of the anode current collector, a third sealing ring arranged on the anode current collector around the first anode active material layer, a second anode active material layer arranged on a second side of the anode current collector, and a fourth sealing ring arranged on the anode current collector around the second anode active material layer,
wherein the third sealing ring seals the anode current collector to one of the S separators around the first anode active material layer, and
wherein the fourth sealing ring seals the anode current collector to one of the S separators around the second anode active material layer.

19. The battery cell of claim 18, further comprising a pouch enclosure surrounding the battery cell stack.

20. The battery cell of claim 19, further comprising a liquid electrolyte in the pouch enclosure.
